(19) United States
(12) Patent Application Publication
(10) Pub. No.: US 2017/0253821 A1
(43) Pub. Date: Sep. 7, 2017

(54) PROCESSES, GAS TURBINE PROCESSES, AND FUEL COMPOSITIONS

(71) Applicant: GENERAL ELECTRIC COMPANY, Schenectady, NY (US)

(72) Inventors: Pierre MONTAGNE, Belfont (FR); Krishnamurthy ANAND, Bangalore (IN); Prajina BHATTACHARYA, Bangalore (IN); Paul Stephen DIMASCIO, Greer, SC (US); Jeffrey Scott GOLDMEER, Latham, NY (US); Abdurrahman Abdallah KHALIDI, Dubai (AE); Praveen Babulal JAIN, Dubai (AE); Adarsh SHUKLA, Bangalore (IN); Eklavya CALLA, Bangalore (IN); Paul Burchell GLASER, Greenville, SC (US)

(21) Appl. No.: 15/058,305

(22) Filed: Mar. 2, 2016

(51) Int. Cl. C10L 10/04; C10L 1/04; C10L 1/12; F02C 7/22

(52) U.S. Cl. CPC C10L 10/04; F02C 7/22; C10L 1/04; C10L 1/1216; F05D 2220/32; F05D 2240/35; C10L 2200/0218; C10L 2270/04

(57) ABSTRACT

A gas turbine process includes supplying a fuel to a gas turbine, combusting the fuel in the gas turbine with a hot gas path temperature reaching at least 1100° C. during operation of the gas turbine, and supplying an inhibition composition including at least one yttrium-containing inorganic compound to interact with the vanadium and inhibit vanadium hot corrosion in the gas turbine caused by vanadium as a fuel impurity in the fuel. A process includes supplying an inhibition composition including at least one yttrium-containing inorganic compound to a hot gas path or a combustor of a gas turbine. A fuel composition includes a fuel including at least one fuel impurity including vanadium and an inhibition composition including at least one yttrium-containing compound. An atomic ratio of yttrium to vanadium in the fuel composition is in a range of 1 to 1.5.

### FIELD OF THE INVENTION

The present invention is directed to methods and compositions for protecting articles. More particularly, the present invention is directed to methods and compositions for protecting articles, such as turbine components, using inhibitors to react with undesirable fuel contaminants.

### BACKGROUND OF THE INVENTION

Modern high-efficiency combustion turbines have firing temperatures that exceed about 2000° F. (1093° C.), and firing temperatures continue to increase as demand for more efficient engines continues. Many components that form the combustor and “hot gas path” turbine sections are directly exposed to aggressive hot combustion gases, for example, the combustor liner, the transition duct between the combustion and turbine sections, and the turbine stationary vanes and rotating blades and surrounding ring segments. In addition to thermal stresses, these and other components are also exposed to mechanical stresses and loads that further wear on the components.

Gas turbine engines may be operated using a number of different fuels. These fuels are combusted in the combustor section of the engine at temperatures at or in excess of 2000° F. (1093° C.), and the gases of combustion are used to rotate the turbine section of the engine, located aft of the combustor section of the engine. Power is generated by the rotating turbine section as energy is extracted from the hot gases of combustion. It is generally economically beneficial to operate the gas turbine engines using the most inexpensive fuel supply available. Two of the more abundant and inexpensive petroleum fuels are crude oil and heavy fuel oil. One of the reasons that they are economical fuels is that they are not heavily refined. Not being heavily refined, they may contain a number of impurities.

Heavy fuel oils typically contain several metallic elemental contaminants entrained as organic or inorganic complexes. These metallic elements, which may include one or more of sodium, potassium, vanadium, lead, and nickel, interact with oxygen and sulfur during combustion, including oxidation in the combustion plume, to form reaction products, including low melting point oxides. Sodium and potassium are conventionally removed prior to being injected into the combustion chambers by using an upstream fuel oil treatment system. Elements, such as vanadium and lead, are difficult to remove from the fuel by upstream accessories means.

The reaction products are problematic for at least two reasons. First, sodium vanadate, vanadium oxide, sodium sulfate, potassium sulfate, and lead oxide are extremely corrosive for the hot gas path alloys, including nickel-based and cobalt-based superalloys. Second, conventional inhibitors used to inhibit vanadium, in particular magnesium, must be introduced in large quantities in high excess to be efficient.

The molten oxides formed from the metal impurities react aggressively with native oxides formed in the nickel-based and cobalt-based alloys and induce rapid hot corrosion. Thermal barrier coatings on the nickel-based and cobalt-based alloys may be used to try to protect the parts and reduce corrosion, but some molten oxides, including vanadium oxide, are able to attack and react with some thermal barrier coatings to remove or degrade the thermal barrier coatings.

The use of magnesium as an inhibitor leads to formation of magnesium vanadate (Mg₃V₂O₈), which has a relatively high melting point (1074° C.) that is sufficient for some gas turbines but limits its use for higher-firing temperature machines. The high excess molar ratio of Mg/V=6.3:1 conventionally used results in the formation of high MgSO₄-content ash from the excess magnesium.

Magnesium is ineffective as an inhibitor when lead, nickel, sodium, or potassium is present in the fuel in addition to the vanadium. Although lead is not typically seen in heavy fuel oil, when present, it may form a low melting point lead oxide (888° C.), which is very corrosive. When sodium and/or potassium are present with vanadium in a sulfur-containing fuel, the amount of magnesium needed to inhibit the vanadium is even higher and the effective molar ratio of Mg/V may be as high as 11:1. When magnesium is used as the inhibitor, the generated ash has a low density of about 2.36 g/cc, leading to a large volume of ash generated. In any case, use of magnesium as an inhibitor results in high deposit rate on the hot gas path, fast fouling, and losses in gas turbine performance.

While vanadium is effectively generally neutralized by magnesium-based inhibitors, the volume of ash generated is high and is directly proportional to the amount of vanadium present. The reaction chemistry for magnesium inhibition has a Mg/V=3 mass balance such that 10.6 moles of reaction product is formed for every mole of vanadium present, giving rise to a large volume of ash deposition, which chokes the flow, and reduces power output, in turn driving frequent water wash cycles. Even though it is technically achievable, neutralization of vanadium above 100 ppm in the fuel would require a gas turbine water wash so frequently to remove deposits as to be impractical.

### BRIEF DESCRIPTION OF THE INVENTION

In an exemplary embodiment, a gas turbine process includes supplying a fuel to a gas turbine, combusting the fuel in the gas turbine with a hot gas path temperature reaching at least 1100° C. during operation of the gas turbine, and supplying an inhibition composition including at least one yttrium-containing inorganic compound to interact with the vanadium and inhibit vanadium hot corrosion in the gas turbine caused by vanadium as a fuel impurity in the fuel.

In another exemplary embodiment, a process includes supplying an inhibition composition including at least one yttrium-containing inorganic compound to a hot gas path or a combustor of a gas turbine.

In another exemplary embodiment, a fuel composition includes a fuel including at least one fuel impurity including vanadium and an inhibition composition including at least one yttrium-containing compound. An atomic ratio of yttrium to vanadium in the fuel composition is in a range of 1 to 1.5.

Other features and advantages of the present invention will be apparent from the following more detailed description of the preferred embodiment.

### DETAILED DESCRIPTION OF THE INVENTION

Provided are exemplary processes and compositions for dealing with fuel impurities in gas turbine systems. Embodiments of the present disclosure, in comparison to compositions and methods not utilizing one or more features disclosed herein, provide a lower volume of ash generated during corrosion inhibition compared to magnesium ash generation; allow for longer time intervals between water wash cycles; provide a higher melting point vanadium reaction product; provide ash products that are highly refractory, that do not tend to stick on the hot gas path, that are not fully sintered, and that are more easily mechanically washable than magnesium ash products; inhibit corrosion caused by fuel impurities, including vanadium, lead, and nickel; promote the formation of lead sulfates from any lead impurities present rather than lead oxide; promote the formation of nickel sulfate from any nickel impurities present; include forms of yttrium more readily available through existing supply chains and more cost-effective than organometallic forms of yttrium; allow higher gas turbine firing temperatures; or a combination thereof.

Thermochemistry is leveraged by the inclusion of yttrium. In some embodiments, the yttrium may be in the form of any soluble or suspended yttrium source. In some embodiments, the yttrium is in the form of an inorganic salt, an inorganic salt powder, an inorganic salt dissolved in water as a nitrate or a sulfate, or an inorganic salt in a fuel-soluble form. The forms of the inorganic salts of yttrium or yttrium oxide particles suspended in water are more commonly-available and less expensive than organometallic forms. In some embodiments, the yttrium is in the form of a hydrocarbon-based slurry, where the viscosity of the medium may be used to stabilize the suspension, rather than a water-based material.

The yttrium acts as an inhibitor to accomplish one or more of the following: i) a conversion of corrosive compounds in the hot gas path into high melting point frangible salts that permit higher firing temperatures, ii) a reduction of the volume of ash generated by using higher valence compounds that form denser reaction products (about 2.5 moles of ash at about 4.2 gm/cc compared to about 10.6 moles of ash at about 2.36 gm/cc), leading to longer time intervals between water wash cycles, iii) driving lead to form lead sulfate instead of a corrosive oxide; and iv) driving nickel to form nickel sulfates so that nickel constituents in the ash are water soluble.

The yttrium-vanadium reaction product, YVO₄, (1810° C.) has a much higher melting point than the magnesium-vanadium reaction product, Mg₃V₂O₈, (1074° C.). This allows for ash products that are not fully sintered, making them more easily washable through mechanical means. The yttrium ash products are also highly refractory and do not tend to stick on the hot gas path. As a result of the better inhibitor chemistry, a lower volume of ash having a higher melting point is produced, lead corrosion is made more benign, and washability with water is achieved by ensuring formation of nickel sulfate from nickel constituents. Nickel sulfate up to exposure temperatures of 1066° C. is water-soluble.

In some embodiments, the entrainment of yttrium-based inorganic salts and oxides along with sulfur already present in the fuel neutralizes the effect of vanadium and lead in the fuel. In some embodiments, yttrium salts decompose and oxidize to release yttrium oxide (Y₂O₃), which combines with vanadium oxide to form yttrium vanadate (YVO₄). In other embodiments, sub-micron particles of yttrium oxide (Y₂O₃), entrained in water with a compatibilizer, neutralize the effect of vanadium. In some embodiments, the compatibilizer is a surfactant. Appropriate surfactants may include, but are not limited to, ethoxylates with alcohol and phenyl groups that are free of sodium. In some embodiments, the compatibilizer is a surface functionalization of the sub-micron particle. Appropriate surface functionalizations may include, but are not limited to, silanizations.

In some embodiments, the yttrium-containing compound is in the form of a nanosuspension in the fuel prior to introduction of the fuel to the hot gas path. In some embodiments, the yttrium-containing compound is in an aqueous phase in the form of an emulsion with the fuel when mixed with the fuel prior to introduction of the fuel to the hot gas path.

In some embodiments, the yttrium inorganic salt is yttrium (III) chloride (YCl₃), yttrium (III) fluoride (YF₃), yttrium (III) iodide (YI₃), yttrium (III) bromide (YBr₃), yttrium (III) nitrate tetrahydrate (Y(NO₃)₃.4H₂O), yttrium (III) nitrate hexahydrate (Y(NO₃)₃.6H₂O), yttrium (III) phosphate (YPO₄), yttrium (III) sulfate octahydrate (Y₂(SO₄)₂8H₂O), or any combination thereof.

For each mole of vanadium oxide (V₂O₅) present in the system, only about 2.5 moles of vanadium-related ash product is generated (2 moles of yttrium vanadate, YVO₄; and 0.5 moles of yttrium oxide, Y₂O₃), contributing to a lower ash volume than when magnesium is the inhibitor. The ash has a density of about 4.2 g/cc, which is higher than the density of magnesium-generated ash, also contributing to a lower ash volume. By binding most, all, or substantially all the vanadium present, yttrium as an inhibitor allows the reaction between lead oxide and sulfur oxide to take place, which leads to the formation of the higher melting point lead sulfate (PbSO₄) compound, thereby mitigating the direct corrosion by molten lead oxide. Lead sulfate melts at 1087° C., whereas lead oxide melts at 888° C. Finally, the inclusion of yttrium as an inhibitor allows nickel, typically present in heavy fuel oil, to convert to nickel sulfate, which is stable up to 1066° C. and is water soluble, making the nickel-containing ash water-soluble.

In some embodiments, the inhibition composition permits the operation of a gas turbine with an unrefined or poorly-refined fuel, including, but not limited to, heavy fuel oil or crude oil, that would otherwise be impractical as a fuel in a gas turbine. In some embodiments, the unrefined or poorly-refined fuel contains at least 90 ppm, alternatively at least 100 ppm, alternatively at least 125 ppm, alternatively at least 150 ppm, alternatively at least 175 ppm, or alternatively at least 200 ppm, of vanadium compounds. In these embodiments, the inhibition composition is supplied at a rate sufficient to inhibit vanadium hot corrosion in the gas turbine caused by vanadium in the fuel to the gas turbine by converting all or substantially all of the vanadium to yttrium vanadate.

In some embodiments, a gas turbine process includes supplying a fuel to a gas turbine, combusting the fuel in the gas turbine, and supplying an inhibition composition including at least one yttrium-containing inorganic compound to the hot gas path. The fuel includes vanadium as a fuel impurity. The gas turbine has a hot gas path reaching a maximum temperature of at least 1100° C., alternatively at least 1150° C., alternatively at least 1200° C., alternatively at least 1250° C., alternatively at least 1300° C., alternatively at least 1350° C., alternatively at least 1400° C., alternatively at least 1450° C., or alternatively at least 1500° C., during operation of the gas turbine. The hot gas path decreases in temperature from the maximum temperature to preferably about 700° C. or lower by the last stage bucket of the gas turbine. A reduction in ash deposition and a reduction in the corrosion depth were demonstrated during testing with yttrium as an inhibitor at a lower temperature (685° C.). The inhibition composition is applied to the hot gas path of the gas turbine to inhibit vanadium hot corrosion in the gas turbine that would otherwise be caused by the vanadium in the fuel.

In some embodiments, the gas turbine process further includes determining a concentration of at least one impurity in the fuel. In some embodiments, the impurity is vanadium. In other embodiments, the impurity is sodium, potassium, vanadium, lead, nickel, or any combination thereof. The concentration of the impurity in the fuel may be determined by one or more of any appropriate characterization techniques. In such embodiments, the rate or amount of the inhibition composition introduced to the hot gas path or to the fuel is selected based on the determined concentration of the at least one impurity in the fuel. In such embodiments, the rate or amount of the inhibitor composition is preferably selected to provide a predetermined ratio between at least one component in the inhibition composition and the impurity quantified in the fuel.

In some embodiments, the inhibition composition is applied to the hot gas path as part of the fuel itself In other embodiments, the inhibition composition is applied directly to the hot gas path as a separate feed input. In some embodiments, the inhibition composition is injected into the hot gas path of the gas turbine. In some embodiments, the inhibition composition is injected into the combustor of the gas turbine. In some embodiments, the inhibition composition is combined with the fuel prior to introduction of the fuel into the combustor. In some embodiments, the inhibition composition is first dissolved or dispersed in water before being injected into the hot gas path or combined with the fuel prior to introduction of the fuel into the combustor. In some embodiments, the inhibition composition includes a yttrium salt dissolved in water and then mixed into the fuel. In some embodiments, the yttrium salt dissolved in water is directly injected into the combustion chamber. In some embodiments, the inhibition composition is injected in the water injection system of the gas turbine. In some embodiments, the inhibition composition is injected in the atomizing air system of the gas turbine.

In some embodiments, the yttrium-containing inorganic compound includes a yttrium sulfate or a yttrium nitrate. In some embodiments, the yttrium-containing inorganic compound is a yttrium-containing inorganic salt in a powder form. In some embodiments, the yttrium-containing inorganic compound includes yttrium oxide and the inhibition composition includes sub-micron particles of the yttrium oxide entrained in water with at least one compatibilizer.

In some embodiments, the fuel includes heavy fuel oil or crude oil. The fuel impurities may also include sodium, potassium, lead, nickel, or combinations thereof. The inhibition composition inhibits corrosion caused by the at least one contaminant in the fuel in a hot gas path of a gas turbine. In some embodiments, the system includes sulfur or a sulfate as a fuel impurity or as part of the inhibition composition, preferably in an amount sufficient to react with any lead or nickel in the system.

The gas turbine process preferably further includes removing an ash product from the gas turbine by washing, where the ash product includes yttrium vanadate, yttrium oxide, and lead sulfate, nickel sulfate, or lead sulfate and nickel sulfate.

In other embodiments, a process includes supplying an inhibition composition including at least one yttrium-containing inorganic compound to a hot gas path of a gas turbine. The inhibition composition may be applied to the hot gas path either as part of the fuel itself or directly to the hot gas path as a separate feed input.

The inhibition composition is preferably applied to the hot gas path at an inhibition rate to inhibit vanadium hot corrosion in the gas turbine caused by vanadium in a fuel to the gas turbine by converting all or substantially all of the vanadium to yttrium vanadate, YVO₄. The fuel preferably includes heavy fuel oil or crude oil.

A fuel composition preferably includes a fuel with at least one fuel impurity including vanadium and an inhibition composition including at least one yttrium-containing inorganic compound. An atomic ratio of yttrium to vanadium in the fuel composition is in the range of 1 to 1.5, alternatively in the range of 1.1 to 1.4, or alternatively in the range of 1.2 to 1.3.

In some embodiments, the fuel impurities further include at least one contaminant of sodium, potassium, lead, nickel, and any combination thereof. The inhibition composition inhibits vanadium hot corrosion and corrosion caused by the contaminant in the fuel in a hot gas path of a gas turbine.

Other elements, including, but not limited to, bismuth, antimony, and sodium, react with vanadium and may be included in an inhibition composition. These elements also form vanadates but the reaction compounds have lower melting points, making them less desirable as inhibitors in high-temperature gas turbine systems. Yttrium may also be supplied as part of an organic compound, but with a typical rate of consumption of hundreds of pounds per machine per day, such compounds become extremely expensive as inhibitors.

Chemical tests and burner rig tests were performed to confirm successful inhibition of vanadium by entraining yttrium-containing inorganic salt in the fuel.

### EXAMPLE 1

Vanadium, nickel, sulfur, calcium, zinc, iron, lead, and aluminum were added as contaminants at the expected maximum concentration levels in soluble forms to Type II diesel fuel. Magnesium or yttrium was also added to the Type II diesel fuel as an inhibitor. The fuel was combusted to convert the contaminants to their respective oxides or sulfates and have the same react with the inhibitor oxides that formed during combustion. The temperature was maintained within Stage 1 nozzle levels and Stage 3 bucket levels to map the temperature space. Samples of hot gas path materials were placed as pins in a pin holder and were exposed to the combustion gas plume containing the contaminant oxides and sulfates along with the combustion gases. The pins were then pulled out and the amount of corrosion was determined based on the loss in diameter of the pin measured by optical microscopy. The observed reactions occurred as expected based on thermodynamic calculations and the desired reaction products were expected and found to be thermodynamically stable.

### EXAMPLE 2

In other tests, diesel fuel intentionally charged with sulfur was burnt in a combustion chamber. Metal rods were located in two parallel experimental chambers downstream of the combustor, where temperature was controlled at 910° C. for the first experiment, and 685° C. for the second experiment. Vanadium was introduced to both chambers, and magnesium was introduced in one chamber, while yttrium was introduced in the other chamber. Weight analysis and metallographic analysis showed much lower deposit and corrosion depths on the rods where yttrium was used as the inhibitor.

### EXAMPLE 3

Another test was done using a high velocity oxygen flame burner test blowing at high velocity on a metal piece. Kerosene fuel was intentionally charged with sulfur and polluted with vanadium and either yttrium or magnesium. Results showed about a ten-fold lower deposit amount of ash on the metal pieces where yttrium was used relative to where magnesium was used.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A gas turbine process, comprising:
supplying a fuel to a gas turbine, the fuel comprising at least one fuel impurity comprising vanadium;
combusting the fuel in the gas turbine having a hot gas path temperature reaching at least 1100° C. during operation of the gas turbine; and
supplying an inhibition composition comprising at least one yttrium-containing compound to interact with the vanadium and inhibit vanadium hot corrosion in the gas turbine caused by the vanadium in the fuel.

2. The gas turbine process of claim 1, wherein the yttrium-containing compound is a yttrium-containing inorganic salt selected from the group consisting of yttrium (III) fluoride (YF₃), yttrium (III) iodide (YI₃), yttrium (III) bromide (YBr₃), yttrium (III) nitrate tetrahydrate (Y(NO₃)₃.4H₂O), yttrium (III) nitrate hexahydrate (Y(NO₃)₃.6H₂O), yttrium (III) phosphate (YPO₄), yttrium (III) sulfate octahydrate (Y₂(SO₄)₂8H₂O), and any combination thereof.

3. The gas turbine process of claim 1, wherein supplying the inhibition composition comprises injecting the inhibition composition into a hot gas path of the gas turbine, injecting the inhibition composition into a combustor of the gas turbine, or combining the inhibition composition with the fuel.

4. The gas turbine process of claim 1 further comprising dissolving the inhibition composition in water prior to supplying the inhibition composition, wherein the yttrium-containing compound comprises a yttrium sulfate or a yttrium nitrate.

5. The gas turbine process of claim 1, wherein the yttrium-containing compound is in a soluble or suspended yttrium form.

6. The gas turbine process of claim 1, wherein the yttrium-containing compound comprises yttrium oxide and the inhibition composition comprises sub-micron particles of the yttrium oxide entrained in water with at least one compatibilizer.

7. The gas turbine process of claim 1, wherein the fuel comprises heavy fuel oil or crude oil.

8. The gas turbine process of claim 1, wherein the at least one fuel impurity further comprises at least one contaminant selected from the group consisting of sodium, potassium, lead, nickel, and any combination thereof and wherein the inhibition composition inhibits corrosion caused by the at least one contaminant in the fuel in the hot gas path of the gas turbine.

9. The gas turbine process of claim 8, wherein the at least one fuel impurity further comprises sulfur or a sulfate or the inhibition composition further comprises sulfur or a sulfate.

10. The gas turbine process of claim 9 further comprising removing an ash product from the gas turbine by washing, wherein the ash product comprises yttrium vanadate, yttrium oxide, and at least one compound selected from the group consisting of lead sulfate and nickel sulfate.

11. A process, comprising:
supplying an inhibition composition comprising at least one yttrium-containing compound to a hot gas path or a combustor of a gas turbine.

12. The process of claim 11, wherein the yttrium-containing compound is a yttrium-containing inorganic salt selected from the group consisting of yttrium (III) fluoride (YF₃), yttrium (III) iodide (YI₃), yttrium (III) bromide (YBr₃), yttrium (III) nitrate tetrahydrate (Y(NO₃)₃.4H₂O), yttrium (III) nitrate hexahydrate (Y(NO₃)₃.6H₂O), yttrium (III) phosphate (YPO₄), yttrium (III) sulfate octahydrate (Y₂(SO₄)₂8H₂O), and any combination thereof.

13. The process of claim 11, wherein supplying the inhibition composition comprises injecting the inhibition composition into a hot gas path of the gas turbine, injecting the inhibition composition into a combustor of the gas turbine, or combining the inhibition composition with a fuel prior to injection of the fuel into the combustor.

14. The process of claim 11 comprising dissolving the inhibition composition in water prior to supplying the inhibition composition, wherein the yttrium-containing compound comprises a yttrium sulfate or a yttrium nitrate.

15. The process of claim 11, wherein the yttrium-containing compound is in a soluble or suspended yttrium form.

16. The process of claim 11, wherein the yttrium-containing compound comprises yttrium oxide and wherein the inhibition composition comprises sub-micron particles of the yttrium oxide entrained in water with at least one compatibilizer.

17. The process of claim 11, wherein the inhibition composition is applied to the hot gas path at an inhibition rate to inhibit vanadium hot corrosion in the gas turbine caused by vanadium in a fuel to the gas turbine by converting all of the vanadium to yttrium vanadate (YVO₄), wherein the fuel comprises heavy fuel oil or crude oil.

18. A fuel composition, comprising:
a fuel comprising at least one fuel impurity comprising vanadium; and
an inhibition composition comprising at least one yttrium-containing compound;
wherein an atomic ratio of yttrium to vanadium in the fuel composition is in a range of 1 to 1.5.

19. The fuel composition of claim 18, wherein the yttrium-containing compound is a yttrium-containing inorganic salt selected from the group consisting of yttrium (III) fluoride (YF₃), yttrium (III) iodide (YI₃), yttrium (III) bromide (YBr₃), yttrium (III) nitrate tetrahydrate (Y(NO₃)₃.4H₂O), yttrium (III) nitrate hexahydrate (Y(NO₃)₃.6H₂O), yttrium (III) phosphate (YPO₄), yttrium (III) sulfate octahydrate (Y₂(SO₄)₂8H₂O), and any combination thereof.

20. The fuel composition of claim 18, wherein the at least one fuel impurity further comprises at least one contaminant selected from the group consisting of sodium, potassium, lead, nickel, and any combination thereof, and wherein the inhibition composition inhibits vanadium hot corrosion and corrosion caused by the at least one contaminant in the fuel in a hot gas path of a gas turbine.
